(19) United States
(12) Patent Application Publication
(10) Pub. No.: US 2004/0254278 A1
(43) Pub. Date: Dec. 16, 2004

(54) Castable compositions

(76) Inventors: Ludwig Schieferstein, Ratingen (DE); Manfre Gorzinski, Dusseldorf (DE); Harald Frommelius, Monheim (DE); Sonja Budtke, Remscheid (DE); Heinz-Guenther Schulte, Muelheim (DE)

Correspondence Address: COGNIS CORPORATION, PATENT DEPARTMENT, 300 BROOKSIDE AVENUE, AMBLER, PA, 19002, US

(21) Appl. No.: 10/494,990

(22) PCT Filed: Oct. 29, 2002
(86) PCT No.: PCT/EP02/12048

(30) Foreign Application Priority Data
Nov. 7, 2001 (DE) 101 54 626.2

(51) Int. Cl. C08K 5/10; C08K 5/05

(52) U.S. Cl. 524/315; 524/379

(57) ABSTRACT

A castable composition containing: (a) from about 10 to 80% by weight of a carrier medium containing an ester of a C₈₋₂₂ fatty acid and a mono- and/or polyhydric alcohol; and (b) from about 20 to 90% by weight of a polyacrylate, and wherein the composition is liquid and pourable at a temperature of about 25° C. and has a VOC content of less than about 0.5% by weight, all weights being based on the weight of the composition

### FIELD OF THE INVENTION

This invention relates to compositions which are liquid and pourable at 25° C. and which consist of a carrier medium in the form of one or more esters of C₈₋₂₂ fatty acids and mono- or polyhydric alcohols and one or more polyacrylates. These compositions are eminently suitable for the production of flow controllers.

### PRIOR ART

Liquid polyacrylate-based flow controllers are generally produced in batches mainly by two methods:

without formulation auxiliaries: this generally has the disadvantage that the polymer formed has a very broad molecular weight distribution so that, where the flow controllers are used in powder coatings, dosing is difficult because, on the one hand, the flow control effect is inadequate or, on the other hand, migration from the powder coating films can occur.

with formulation auxiliaries: for better control of the molecular weight distribution, highly compatible substances which have to be distilled off, such as Guerbet alcohols for example, are used as polymerization auxiliaries. Unfortunately, studies conducted by applicants have shown that the auxiliaries, more particularly Guerbet alcohols, only partly volatilize during stoving (at temperatures of ca. 200° C.) and lead to a thick acrid smoke.

### DESCRIPTION OF THE INVENTION

The problem addressed by the present invention was to provide compositions consisting of a carrier medium and one or more polyacrylates which would satisfy the following requirements: the compositions would be liquid at 25° C., homogeneous, concentrated, pourable, storable and substantially VOC-free. More particularly, these compositions would be suitable for use as flow controllers. These flow controllers would be distinguished from conventional flow controllers not only by a distinct reduction of emissions (substantially VOC-free), but also by good general compatibility in powder coatings.

By “homogeneous” is meant that the polyacrylates are homogeneously distributed in the carrier medium. By “concentrated” is meant that the polyacrylates are present in a quantity of at least 20% by weight, based on the composition as a whole. By “pourable” is meant that the Brookfield viscosity of the composition, as measured at 25° C./10 r.p.m., is below 50,000 mPas. By “storable” is meant that the composition remains stable both chemically (no decomposition of the components) and in regard to consistency (no loss of homogeneity), even in the event of prolonged storage. By “substantially VOC-free” is meant that the composition contains hardly any volatile substances. This means in particular that the carrier medium of the composition has low volatility.

In addition, the composition of the carrier medium would be such that no adverse interactions would occur when the composition of carrier medium and dispersant was used for the production of a paint formulation when the carrier medium would inevitably come into contact with film formers, pigments, fillers and/or paint additives.

The present invention relates to compositions which are liquid and pourable at 25° C. for the formulation of polyacrylate-based flow controllers, characterized in that they consist of

a) 10 to 80% by weight of a carrier medium in the form of one or more esters of C₈₋₂₂ fatty acids and mono- or polyhydric alcohols and

b) 20 to 90% by weight of one or more polyacrylates.

It has surprisingly been found that the compositions according to the invention solve the above-stated problem excellently in every respect. The compositions are liquid, homogeneous, pourable and storable. They are also substantially VOC-free.

The VOC content of a composition may be determined by methods known to the relevant expert. In the context of the present invention, substantially VOC-free means a VOC value of less than 0.5% and preferably less than 0.2%, based on the composition as a whole. For the purposes of the present invention, the VOC content of a sample is determined as follows to DIN 75201 (“Determination of the fogging behavior of materials used for the interior trim of motor vehicles”): the sample is placed on the bottom of a spoutless glass beaker of fixed dimensions. The beaker is covered with an aluminium foil on which volatile constituents from the (test) specimen are able to condense. The aluminium foil is cooled. The beaker thus prepared is placed for 16 hours in a bath thermostat adjusted to a test temperature of 100±0.3° C. The effect of the “fogging” deposit on the aluminium foil is quantitatively determined by weighing the film before and after the fogging test. The VOC value is calculated to the following equation:

VOC value(%)=(A/B)*100

where

A is the quantity of the fogging deposit (in g) and

B is the quantity of the sample used (in g).

In addition, the compositions according to the invention are compatible with the film formers, pigments, fillers and paint additives typically used in the production of paint formulations.

Component a) consists of esters of C₈₋₂₂ fatty acids and mono- or polyhydric alcohols. These act as a carrier medium for component b). They may be used individually or in admixture with one another. Basically, there are no limitations as to the nature of the esters.

In one embodiment, esters of C₈₋₂₂ fatty acids and C₈₋₂₂ fatty alcohols are used as component a). Suitable fatty acid units of these esters are octanoic acid, 2-ethylhexanoic acid, decanoic acid, lauric acid, tridecanoic acid, isotridecanoic acid, myristic acid, pentadecanoic acid, palmitic acid, heptadecanoic acid, stearic acid, 12-hydroxystearic acid, nonadecanoic acid, arachic acid, heneicosanoic acid, behenic acid, 10-undecenoic acid, lauroleic acid, myristoleic acid, palmitoleic acid, oleic acid, petroselic acid, elaidic acid, ricinoleic acid, linoleic acid, linolaidic acid, linolenic acid, elaeostearic acid, gadoleic acid, arachidonic acid, erucic acid, brassidic acid, clupanodonic acid. Suitable fatty alcohol units of the esters are octanol, 2-ethylhexanol, pelargonyl alcohol, decanol, undecanol, lauryl alcohol, tridecyl alcohol, isotridecyl alcohol, myristyl alcohol, pentadecanol, palmityl alcohol, heptadecanol, stearyl alcohol, nonadecanol, arachidyl alcohol, heneicosanol, behenyl alcohol, tricosanol, lignoceryl alcohol, 10-undecanol, oleyl alcohol, elaidyl alcohol, ricinolyl alcohol, linoleyl alcohol, linolenyl alcohol, gadoleyl alcohol, arachidonyl alcohol, erucyl alcohol, brassidyl alcohol.

In one embodiment, pentaerythritol adipate oleate (CAS No. 68130-33-6) is used as component a).

A particularly preferred component a) is isotridecyl stearate.

In another embodiment, esters of C₈₋₂₂ fatty acids and glycerol are used as component a). These are compounds known to the expert which are also referred to as fats and oils.

Component b) is a polyacrylate. Polyacrylates in the context of the present invention are understood to be polymers which contain acrylic acid and/or methacrylic acid units. Basically, there are no limitations as to the nature of the polyacrylates. They may be polymers which are consistently made up of a single type of monomer or of various types of monomers, i.e. they may be homopolymers or copolymers.

In one embodiment, the polyacrylates used are polyalkyl acrylates with an average molecular weight of 3,000 to 100,000 kg/kmol. Particularly preferred alkyl groups are methyl, ethyl, propyl, butyl, ethylhexyl. The polyalkyl acrylates may be present as homopolymers or copolymers.

In one embodiment, copolymers of butyl acrylate and 2-ethylhexyl acrylate are used as component b).

The present invention also relates to compositions for the formulation of polyacrylate-based flow controllers which are liquid and pourable at 25° C. and which consist of a) 10 to 80% by weight of a carrier medium in the form of one or more esters of C₈₋₂₂ fatty acids and mono- or polyhydric alcohols and b) 20 to 90% by weight of one or more polyacrylates, the compositions being produced by first introducing the carrier medium in liquid form, then adding the desired polyacrylate monomers and reacting them in situ to form the polyacrylates. One embodiment is characterized by the use of components a) which have an iodine value below 80. Another embodiment is characterized by the use of components a) which have an iodine value below 10. As known to the expert, the extent to which a compound contains C═C double bonds is characterized by the iodine value. For the purposes of the present invention, the iodine values are calculated by the Hanus or Wijs method, which have long been part of Section C-V of the “DGF-Einheitsmethoden”, or by the equivalent Fiebig method (cf. Fat Sci. Technol. 1991, No. 1, pages 13-19).

The present invention also relates to the use of compositions for formulating polyacrylate-based flow controllers, the compositions being liquid and pourable at 25° C. and consisting of

a) 10 to 80% by weight of a carrier medium in the form of one or more esters of C₈₋₂₂ fatty acids and mono- or polyhydric alcohols and

b) 20 to 90% by weight of one or more polyacrylates.

The present invention also relates to a process for the production of compositions for the formulation of polyacrylate-based flow controllers which are liquid and pourable at 25° C. and which consist of

a) 10 to 80% by weight of a carrier medium in the form of one or more esters of C₈₋₂₂ fatty acids and mono- or polyhydric alcohols and

b) 20 to 90% by weight of one or more polyacrylates,

characterized in that the carrier medium is first introduced in liquid form, the desired polyacrylate monomers are then added and are reacted in situ to form the polyacrylates. One embodiment is characterized by the use of components a) which have an iodine value below 80. Another embodiment is characterized by the use of components a) which have an iodine value below 10. The foregoing observations apply to the iodine value.

### EXAMPLES

Substances Used

Loxiol G40:

Isotridecyl stearate

Uralac P 5127:

Commercially available polyester resin (a product of DSM)

Araldit GT 7004:

Commercially available epoxy resin (Ciba-Geigy)

Kronos 2310:

Titanium dioxide (Kronos)

Benzoin:

Commercially available chemical (Fluka)

Polyacrylate additive I:

Mixture of the following components liquid at 25° C.: 80 parts by weight polyacrylate and 20 parts by weight Loxiol G 40. The mixture of polyacrylate and Loxiol G40 was prepared as follows: 600.0 g Loxiol G 40 were weighed into a 4-liter 4-necked flask equipped with a stirrer, condenser, two dropping funnels and nitrogen inlet and were heated in an oil bath to 140° C. After the target temperature had been reached, the dropwise addition of a mixture of 1920.0 g butyl acrylate and 480.0 g 2-ethlhexyl acrylate and, at the same time, 30.0 g t-butyl perbenzoate was started. The dropwise addition rates were adjusted so that the monomer mixture was uniformly added in five hours and the liquid radical initiator was added in six hours. The reaction took place at a temperature of ca. 138° C. to 142° C. After the initiator had been added, the mixture was left to react for 1 hour at 140° C.

Appearance of the product: light yellow clear solution.

Brookfield viscosity of the product (at 25° C., 20 r.p.m., spindle 5): 9840 mpas.

Polyacrylate master batch I: powder-form mixture of the following components: 90 parts by weight Uralac P 5127 and 10 parts by weight of polyacrylate additive I.

Polyacrylate master batch 11: powder-form mixture of the following components: 90 parts by weight Uralac P 5127 and 10 parts by weight polyacrylate additive I.

### Measuring Methods

Wave Scan Method

The surface profile of the stoved paint films applied was determined by the so-called Wave Scan method which enables the visible profile of paint film surfaces to be measured. To this end, the reflection intensity (“waviness”) was measured with a Wave Scan Plus (manufacturer: Byk-Gardner) at room temperature (20° C.), 1250 measuring points being recorded over a distance of 10 cm. The reflection is divided by the measuring instrument into a long wave value (variance of the light intensity for structures of 0.6 to 10 mm) and a short wave value (structures of 0.1 to 0.6 mm). The measuring range extends from 0 to 99.9 where 0 would signify a mirror-smooth surface. This means that the lower the values, the better the flow of the paint film.

Visual Evaluation

The surface of the paint film was also characterized for any defects, such as pinholes or craters, by visual evaluation.

### Example 1

Step 1:

The following components were weighed together: 268 g Uralac 5127, 300 g Araldit GT 7004, 300 g Kronos 2310, 4.5 g benzoin and 37 g polyacrylate masterbatch 1.

Step 2:

The mixture was predispersed in a Mixaco anchor mixer and then introduced by a Brabender Flexwall feeder into a Werner & Pfleiderer ZSK 25 extruder. The temperature of the extruder was 100° C. and its speed 300 r.p.m. The hybrid paint thus produced was size-reduced at 18,000 r.p.m. in a ZM 100 ultracentrifugal mill and sieved through 100 μm vibrating sieves.

Step 3:

Using a PG1 spray gun (ITW GEMA; 80 KV), the paint was electrostatically applied to phosphated steel plates in an average layer thickness of 64 μ. The plates were then stoved for 20 minutes at 180° C. and tested for flow control both visually and by Wave Scan.

Characterization of the Flow of the Paint Surface

by Wave Scan:

long wave value=49

short wave value=54

Visual:

No surface defects visible.

### Example 2

The procedure was as in Example 1 except that the following components were weighed together in step 1: 238 g Uralac 5127, 300 g Araldit GT 7004, 300 g Kronos 2310, 4.5 g benzoin and 74 g polyacrylate master batch I. In step 3, the paint was applied in an average layer thickness of 64 μm.

Characterization of the Paint Surface

by Wave Scan:

long wave value=27

short wave value=33

Visual:

No surface defects visible.

### Comparison Example 1

Step 1:

The following components were weighed together: 274.6 g Uralac 5127, 300 g Araldit GT 7004, 300 g Kronos 2310, 4.5 g benzoin and 30.78 g polyacrylate masterbatch II.

Step 2:

The mixture was predispersed in a Mixaco anchor mixer and then introduced by a Brabender Flexwall feeder into a Werner & Pfleiderer ZSK 25 extruder. The temperature of the extruder was 100° C. and its speed 300 r.p.m. The hybrid paint thus produced was size-reduced at 18,000 r.p.m. in a ZM 100 ultracentrifugal mill and sieved through 100 μm vibrating sieves.

Step 3:

Using a PGl spray gun (ITW GEMA; 80 KV), the paint was electrostatically applied to phosphated steel plates in an average layer thickness of 88 μm. The plates were then stoved for 20 minutes at 180° C. and tested for flow control both visually and by Wave Scan.

Characterization of the Paint Surface

by Wave Scan:

long wave value=46

short wave value=52

Visual:

Occasional flow defects (craters) visible in the paint surface.

### Comparison Example 2

The procedure was as in Comparison Example 1 except that the following components were weighed together in step 1: 250.4 g Uralac 5127, 300 g Araldit GT 7004, 300 g Kronos 2310, 4.5 g benzoin and 61.6 g polyacrylate master batch II. In step 3, the paint was applied in an average layer thickness of 64 μm.

Characterization of the Paint Surface

by Wave Scan:

long wave value=35

short wave value=37

Visual:

No surface defects visible.

TABLE 1

| | Long wave value | Short wave value | Visual evaluation |
|---|---|---|---|
| Example 1 | 49 | 54 | No defects |
| Comparison | 46 | 52 | Contains craters |
| Example 1 | | | |
| Example 2 | 27 | 33 | No defects |
| Comparison | 35 | 37 | No defects |
| Example 2 | | | |

Preparation of a Mixture of a) and b) According to the Invention with in situ Preparation of Component a)

Reference is made here to the “Substances used” section, more particularly to the observations under “polyacrylate additive I”. The preparation of a mixture of polyacrylate and Loxiol G 40 liquid at 25° C. is explicitly described there. The mixture had a Brookfield viscosity of 9840 mPas (as measured at 25° C., 20 r.p.m., spindle 5).

1-6. (cancelled).

7. A castable composition comprising:
(a) from about 10 to 80% by weight of a carrier medium containing an ester of a C₈₋₂₂ fatty acid and a mono- and/or polyhydric alcohol; and
(b) from about 20 to 90% by weight of a polyacrylate, and wherein the composition is liquid and pourable at a temperature of about 25° C. and has a VOC content of less than about 0.5% by weight, all weights being based on the weight of the composition.

8. The composition of claim 7 wherein the composition has a VOC content of less than about 0.2% by weight, based on the weight of the composition.

9. The composition of claim 7 wherein (a) has an iodine value of less than 80.

10. The composition of claim 7 wherein (a) has an iodine value of less than 10.

11. The composition of claim 7 wherein (a) is isotridecyl stearate.

12. The composition of claim 7 wherein (b) is a copolymer of butyl acrylate and 2-ethylhexyl acrylate.

13. A process for making a castable composition which is pourable at a temperature of about 25° C. and has a VOC content of less than about 0.5% by weight, comprising:
(a) providing from about 10 to 80% by weight of a carrier medium containing an ester of a C₈₋₂₂ fatty acid and a mono- and/or polyhydric alcohol;
(b) providing from about 20 to 90% by weight of a polyacrylate; and
(c) combining (a) and (b) to form the composition, and wherein (b) is formed by adding polyacrylate monomers to (a) and reacting them in situ.

14. The process of claim 13 wherein the composition has a VOC content of less than about 0.2% by weight, based on the weight of the composition.

15. The process of claim 13 wherein (a) has an iodine value of less than 80.

16. The process of claim 13 wherein (a) has an iodine value of less than 10.

17. The process of claim 13 wherein (a) is isotridecyl stearate.

18. The process of claim 13 wherein (b) is a copolymer of butyl acrylate and 2-ethylhexyl acrylate.
